(19) United States
(12) Patent Application Publication
(10) Pub. No.: US 2005/0186397 A1
(43) Pub. Date: Aug. 25, 2005

(54) Fibrous structures with improved softness

(75) Inventors: Michael Scott Prodoehl, West Chester, OH (US); Kenneth Douglas Vinson, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/782,029

(22) Filed: Feb. 19, 2004

(51) Int. Cl. B32B 5/14; B32B 7/02

(52) U.S. Cl. 428/171; 442/381; 442/414; 428/218

(57) ABSTRACT

Fibrous structures exhibiting improved softness and single- or multi-ply sanitary tissue products comprising such fibrous structures are provided by the present invention.

### FIELD OF THE INVENTION

The present invention relates to fibrous structures with improved softness. More particularly it relates to differential density fibrous structures having certain material and/or physical properties that result in the fibrous structures exhibiting a certain modulus to tensile strength ratio. The modulus to tensile strength ratio exhibited by the fibrous structures of the present invention results in the fibrous structures exhibiting unexpected enhanced softness properties as compared to fibrous structures that have different material and/or physical properties and/or different modulus to tensile strength ratios. The present invention also relates to single- or multi-ply sanitary tissue products comprising a fibrous structure in accordance with the present invention.

### BACKGROUND OF THE INVENTION

Consumers identify softness of fibrous structures, especially fibrous structures that are incorporated into sanitary tissue products, particularly toilet tissue, as a very important consumer need. It is known that one component of softness impression is related to the stiffness of a fibrous structure and that tensile modulus, the slope of the load-elongation curve is related to stiffness.

Historically, tensile modulus (hereinafter, modulus) and tensile failure load (hereinafter tensile strength) in fibrous structures have been coupled such that if a fibrous structure had a high tensile strength that same fibrous structure would have a high modulus and thus, would be considered by consumers to be lacking in softness. The same was true for fibrous structures that had a high modulus; that same fibrous structure would have a high tensile strength and thus, would be considered by consumers to be lacking in softness. One method of overcoming this contradiction has been to employ a majority of relatively long fibers, e.g. to achieve an average fiber length, L, exceeding about 2.0 mm. Unfortunately, this method is accompanied by several negatives including higher raw material costs; difficulties in forming a uniform, opaque sheet; and degradation of papermaking rate.

Formulators of fibrous structures have continued to pursue improving softness in fibrous structures. Advances have been made in the prior art. However, there still exists a strong consumer need for additional softness improvements in fibrous structures.

### SUMMARY OF THE INVENTION

The present invention fulfills the strong consumer need identified above by providing fibrous structures having improved softness as compared to prior art fibrous structures.

It has been unexpectedly found that modulus and tensile strength within fibrous structures can be decoupled. In other words, a fibrous structure of the present invention exhibits a high tensile strength and surprisingly a low modulus. The low modulus of the fibrous structures of the present invention provides the fibrous structures with a softness that is greater than conventional fibrous structures and/or higher tensile strength fibrous structures with a softness that is equal to or greater than the softness of conventional fibrous structures.

In one aspect of the present invention, a fibrous structure, preferably a differential density fibrous structure, preferably having an average fiber length, L, of less than 2.0 mm and/or less than 1.8 mm and/or less than 1.6 mm, comprising a structural aspect ratio of greater than 1.5 wherein the differential density fibrous structure exhibits a modulus to tensile strength ratio as defined below:

$$\frac{{ARD}_{90} M}{{ARD}_{90} T} < 15$$

wherein ARD₉₀M is the modulus measured perpendicular to the direction the structural aspect ratio is measured; and ARD₉₀ T is the tensile strength measured perpendicular to the direction the structural aspect ratio is measured, is provided.

In another aspect of the present invention, a fibrous structure, preferably a differential density fibrous structure, having an average fiber length, L, of less than 2.0 mm and/or less than 1.8 mm and/or less than 1.6 mm, comprising a maximum stretch of less than about 15% wherein the differential density fibrous structure exhibits a modulus to tensile strength ratio as defined below:

$$\frac{MSD M}{MSD T} < 15$$

wherein MSD M is the modulus measured in the direction of the maximum stretch; and MSD T is the tensile strength measured in the direction of the maximum stretch, is provided.

In yet another aspect of the present invention, a single- or multi-ply sanitary tissue product comprising a fibrous structure, preferably a differential density fibrous structure, in accordance with the present invention, is provided.

Accordingly, the present invention provides fibrous structures that exhibit unexpected improved softness and single- or multi-ply sanitary tissue products comprising such fibrous structures.

### BRIEF DESCRIPTION OF THE DRAWINGS

FIGS. 1 and 2 are schematic representations of a fibrous structure provided to illustrate the algorithm for determining the structural aspect ratio.

FIG. 1, illustrates a field of the patterned densified structure showing the repeating nature of the discontinuous differential density areas.

FIG. 2a, is a representation of the smallest repeat unit of the pattern area of FIG. 1 with illustrations showing the algorithm for determining structural aspect ratio in a specified direction.

FIG. 2b, is a representation of the smallest repeat unit of the pattern area as shown in FIG. 2a with illustrations showing parallel lines orthogonal to line X from FIG. 2a.

### DETAILED DESCRIPTION OF THE INVENTION

“Fiber” as used herein means an elongate particulate having an apparent length greatly exceeding its apparent width, i.e. a length to diameter ratio of at least about 10. More specifically, as used herein, “fiber” refers to papermaking fibers. The present invention contemplates the use of a variety of papermaking fibers, such as, for example, natural fibers or synthetic fibers, or any other suitable fibers, and any combination thereof. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. U.S. Pat. No. 4,300,981 and U.S. Pat. No. 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking.

In addition to the various wood pulp fibers, other cellulosic fibers such as cotton linters, rayon, and bagasse can be used in this invention. Synthetic fibers such as rayon and other polymeric fibers such as polypropylene, polyethylene, polyester, polyolefin, polyethylene terephthalate and nylon and various hydroxyl polymers, can be used. The polymeric fibers can be produced by spunbond processes, meltblown processes, and other suitable methods known in the art.

In addition to wood pulps, fibers may be produced and/or obtained from vegetable sources such as corn (i.e., starch).

The fibers may be short or long (e.g., NSK fibers). Nonlimiting examples of short fibers include fibers derived from a fiber source selected from the group consisting of Acacia, Eucalyptus, Maple, Oak, Aspen, Birch, Cottonwood, Alder, Ash, Cherry, Elm, Hickory, Poplar, Gum, Walnut, Locust, Sycamore, Beech, Catalpa, Sassafras, Gmelina, Albizia, Anthocephalus, Magnolia, Bagasse, Flax, Hemp, Kenaf and mixtures thereof.

“Sanitary tissue product” as used herein means a wiping implement for post-urinary and post-bowel movement cleaning (toilet tissue), for otorhinolaryngological discharges (facial tissue), and multi-functional absorbent and cleaning uses (absorbent towels).

“Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121.

“Basis Weight” as used herein is the weight per unit area of a sample reported in lbs/3000 ft² or g/m². Basis weight is measured by preparing one or more samples of a certain area (m²) and weighing the sample(s) of a fibrous structure according to the present invention and/or a paper product comprising such fibrous structure on a top loading balance with a minimum resolution of 0.01 g. The balance is protected from air drafts and other disturbances using a draft shield. Weights are recorded when the readings on the balance become constant. The average weight (g) is calculated and the average area of the samples (m²) is measured. The basis weight (g/m²) is calculated by dividing the average weight (g) by the average area of the samples (m²).

“Machine Direction” or “MD” as used herein means the direction parallel to the flow of the fibrous structure through the papermaking machine and/or product manufacturing equipment.

“Cross Machine Direction” or “CD” as used herein means the direction perpendicular to the machine direction in the same plane of the fibrous structure and/or paper product comprising the fibrous structure.

“Aspect Ratio” as used herein means a ratio of length to width within discontinous regions of the differential density structures of the present invention. More specifically, the “Structural Aspect Ratio” is determined by averaging the aspect ratio of all of the individual discontinuous regions within a repeating unit, wherein the direction in which the structural aspect ratio is measured is selected in order to achieve a maximum in its absolute value.

“Dry Tensile Strength” (or simply “Tensile Strength” as used herein) of a fibrous structure of the present invention and/or a paper product comprising such fibrous structure is measured as follows. One (1) inch by five (5) inch (2.5 cm×12.7 cm) strips of fibrous structure and/or paper product comprising such fibrous structure are provided. The strip is placed on an electronic tensile tester Model 1122 commercially available from Instron Corp., Canton, Mass. in a conditioned room at a temperature of 73° F.±4° F. (about 28° C.±2.2° C.) and a relative humidity of 50%±10%. The crosshead speed of the tensile tester is 2.0 inches per minute (about 5.1 cm/minute) and the gauge length is 4.0 inches (about 10.2 cm). The Dry Tensile Strength can be measured in any direction by this method. The “Total Dry Tensile Strength” or “TDT” is the special case determined by the arithmetic total of MD and CD tensile strengths of the strips.

“Modulus” or “Tensile Modulus” as used herein means the slope tangent to the load elongation curve taken at the point corresponding to 15 g/cm-width upon conducting a tensile measurement as specified in the foregoing.

“Peak Load Stretch” (or simply “Stretch”) as used herein is determined by the following formula:

$$\frac{\begin{matrix}Length of Fibrous {Structure}_{PL} - \\ Length of Fibrous {Structure}_{I}\end{matrix}}{Length of Fibrous {Structure}_{I}} \times 100$$

wherein:
Length of Fibrous Structure_{PL} is the length of the fibrous structure at peak load;
Length of Fibrous Structure₁ is the initial length of the fibrous structure prior to stretching;
The Length of Fibrous Structure_{PL} and Length of Fibrous Structure₁ are observed while conducting a tensile measurement as specified in the above. The tensile tester calculates the stretch at Peak Load. Basically, the tensile tester calculates the stretches via the formula above.

“Caliper” as used herein means the macroscopic thickness of a sample. Caliper of a sample of fibrous structure according to the present invention is determined by cutting a sample of the fibrous structure such that it is larger in size than a load foot loading surface where the load foot loading surface has a circular surface area of about 3.14 in² (20.3 cm²). The sample is confined between a horizontal flat surface and the load foot loading surface. The load foot loading surface applies a confining pressure to the sample of 15.5 g/cm² (about 0.21 psi). The caliper is the resulting gap between the flat surface and the load foot loading surface. Such measurements can be obtained on a VIR Electronic Thickness Tester Model II available from Thwing-Albert Instrument Company, Philadelphia, Pa. The caliper measurement is repeated and recorded at least five (5) times so that an average caliper can be calculated. The result is reported in millimeters.

“Apparent Density” or “Density” as used herein means the basis weight of a sample divided by the caliper with appropriate conversions incorporated therein. Apparent density used herein has the units g/cm³.

“Softness” of a fibrous structure according to the present invention and/or a paper product comprising such fibrous structure is determined as follows. Ideally, prior to softness testing, the samples to be tested should be conditioned according to Tappi Method #T4020M-88. Here, samples are preconditioned for 24 hours at a relative humidity level of 10 to 35% and within a temperature range of 22° C. to 40° C. After. this preconditioning step, samples should be conditioned for 24 hours at a relative humidity of 48% to 52% and within a temperature range of 22° C. to 24° C. Ideally, the softness panel testing should take place within the confines of a constant temperature and humidity room. If this is not feasible, all samples, including the controls, should experience identical environmental exposure conditions.

Softness testing is performed as a paired comparison in a form similar to that described in “Manual on Sensory Testing Methods”, ASTM Special Technical Publication 434, published by the American Society For Testing and Materials 1968 and is incorporated herein by reference. Softness is evaluated by subjective testing using what is referred to as a Paired Difference Test. The method employs a standard external to the test material itself. For tactile perceived softness two samples are presented such that the subject cannot see the samples, and the subject is required to choose one of them on the basis of tactile softness. The result of the test is reported in what is referred to as Panel Score Unit (PSU). With respect to softness testing to obtain the softness data reported herein in PSU, a number of softness panel tests are performed. In each test ten practiced softness judges are asked to rate the relative softness of three sets of paired samples. The pairs of samples are judged one pair at a time by each judge: one sample of each pair being designated X and the other Y. Briefly, each X sample is graded against its paired Y sample as follows:
1. a grade of plus one is given if X is judged to may be a little softer than Y, and a grade of minus one is given if Y is judged to may be a little softer than X;
2. a grade of plus two is given if X is judged to surely be a little softer than Y, and a grade of minus two is given if Y is judged to surely be a little softer than X;
3. a grade of plus three is given to X if it is judged to be a lot softer than Y, and a grade of minus three is given if Y is judged to be a lot softer than X; and, lastly:
4. a grade of plus four is given to X if it is judged to be a whole lot softer than Y, and a grade of minus 4 is given if Y is judged to be a whole lot softer than X.

The grades are averaged and the resultant value is in units of PSU. The resulting data are considered the results of one panel test. If more than one sample pair is evaluated then all sample pairs are rank ordered according to their grades by paired statistical analysis. Then, the rank is shifted up or down in value as required to give a zero PSU value to which ever sample is chosen to be the zero-base standard. The other samples then have plus or minus values as determined by their relative grades with respect to the zero base standard. The number of panel tests performed and averaged is such that about 0.2 PSU represents a significant difference in subjectively perceived softness.

“Ply” or “Plies” as used herein means an individual fibrous structure optionally to be disposed in a substantially contiguous, face-to-face relationship with other plies, forming a multiple ply fibrous structure. It is also contemplated that a single fibrous structure can effectively form two “plies” or multiple “plies”, for example, by being folded on itself.

“Fiber Length”, “Average Fiber Length” and “Weighted Average Fiber Length”, are terms used interchangeably herein all intended to represent the “Length Weighted Average Fiber Length” as determined for example by means of a Kajaani FiberLab Fiber Analyzer commercially available from Metso Automation, Kajaani Finland. The instructions supplied with the unit detail the formula used to arrive at this average. The recommended method for measuring fiber length using this instrument is essentially the same as detailed by the manufacturer of the FiberLab in its operation manual. The recommended consistencies for charging to the FiberLab are somewhat lower than recommended by the manufacturer since this gives more reliable operation. Short fiber furnishes, as defined herein, should be diluted to 0.02-0.04% prior to charging to the instrument. Long fiber furnishes, as defined herein, should be diluted to 0.15%-0.30%. Alternatively, fiber length may be determined by sending the short fibers to a contract lab, such as Integrated Paper Services, Appleton, Wis.

As used herein, the articles “a” and “an” when used herein, for example, “an anionic surfactant” or “a fiber” is understood to mean one or more of the material that is claimed or described.

All percentages and ratios are calculated by weight unless otherwise indicated. All percentages and ratios are calculated based on the total composition unless otherwise indicated.

Unless otherwise noted, all component or composition levels are in reference to the active level of that component or composition, and are exclusive of impurities, for example, residual solvents or by-products, which may be present in commercially available sources.

Fibrous Structure:

The present invention is applicable to fibrous structures in general, including but not limited to conventionally felt-pressed fibrous structures; pattern densified fibrous structures; and high-bulk, uncompacted fibrous structures. The fibrous structures may be of a homogenous or multilayered construction; and the sanitary tissue products made therefrom may be of a single-ply or multi-ply construction.

The fibrous structures of the present invention and/or sanitary tissue products comprising such fibrous structures may have a basis weight of between about 10 g/m² to about 120 g/m² and/or from about 14 g/m² to about 80 g/m² and/or from about 20 g/m² to about 60 g/m².

The fibrous structures of the present invention and/or sanitary tissue products comprising such fibrous structures may have a total dry tensile strength of greater than about 59 g/cm (150 g/in) and/or from about 78 g/cm (200 g/in) to about 394 g/cm (1000 g/in) and/or from about 98 g/cm (250 g/in) to about 335 g/cm (850 g/in).

The fibrous structures of the present invention and/or sanitary tissue products comprising such fibrous structures may have a density of about 0.60 g/cc or less and/or about 0.30 g/cc or less and/or from about 0.04 g/cc to about 0.20 g/cc.

In one embodiment, the fibrous structure of the present invention is a pattern densified fibrous structure characterized by having a relatively high-bulk field of relatively low fiber density and an array of densified zones of relatively high fiber density. The high-bulk field is alternatively characterized as a field of pillow regions. The densified zones are alternatively referred to as knuckle regions. The densified zones may be discretely spaced within the high-bulk field or may be interconnected, either fully or partially, within the high-bulk field. Processes for making pattern densified fibrous structures are well known in the art as exemplified in U.S. Pat. Nos. 3,301,746, 3,974,025, 4,191,609 and 4,637,859.

In general, pattern densified fibrous structures are preferably prepared by depositing a papermaking furnish on a foraminous forming wire such as a Fourdrinier wire to form a wet fibrous structure and then juxtaposing the fibrous structure against a three-dimensional substrate comprising an array of supports. The fibrous structure is pressed against the three-dimensional substrate, thereby resulting in densified zones in the fibrous structure at the locations geographically corresponding to the points of contact between the array of supports and the wet fibrous structure. The remainder of the fibrous structure not compressed during this operation is referred to as the high-bulk field. This high-bulk field can be further dedensified by application of fluid pressure, such as with a vacuum type device or a blow-through dryer, or by mechanically pressing the fibrous structure against the array of supports of the three-dimensional substrate. The fibrous structure is dewatered, and optionally predried, in such a manner so as to substantially avoid compression of the high-bulk field. This is preferably accomplished by fluid pressure, such as with a vacuum type device or blow-through dryer, or alternately by mechanically pressing the fibrous structure against an array of supports of the three-dimensional substrate wherein the high-bulk field is not compressed. The operations of dewatering, optional predrying and formation of the densified zones may be integrated or partially integrated to reduce the total number of processing steps performed. Subsequent to formation of the densified zones, dewatering, and optional predrying, the fibrous structure is dried to completion, preferably still avoiding mechanical pressing. Preferably, from about 8% to about 65% of the fibrous structure surface comprises densified knuckles, the knuckles preferably having a relative density of at least 125% of the density of the high-bulk field.

The three-dimensional substrate comprising an array of supports is preferably an imprinting carrier fabric having a patterned displacement of knuckles which operate as the array of supports which facilitate the formation of the densified zones upon application of pressure. The pattern of knuckles constitutes the array of supports previously referred to. Imprinting carrier fabrics are well known in the art as exemplified in U.S. Pat. Nos. 3,301,746, 3,821,068, 3,974,025, 3,573,164, 3,473,576, 4,239,065 and 4,528,239.

In one embodiment, the papermaking furnish is first formed into a wet fibrous structure on a foraminous forming carrier, such as a Fourdrinier wire. The fibrous structure is dewatered and transferred to a three-dimensional substrate (also referred to generally as an “imprinting fabric”). The furnish may alternately be initially deposited on a three-dimensional foraminous supporting carrier. Once formed, the wet fibrous structure is dewatered and, preferably, thermally predried to a selected fiber consistency of between about 40% and about 80%. Dewatering is preferably performed with suction boxes or other vacuum devices or with blow-through dryers. The knuckle imprint of the imprinting fabric is impressed in the fibrous structure as discussed above, prior to drying the fibrous structure to completion. One method for accomplishing this is through application of mechanical pressure. This can be done, for example, by pressing a nip roll which supports the imprinting fabric against the face of a drying drum, such as a Yankee dryer, wherein the fibrous structure is disposed between the nip roll and drying drum. Also, preferably, the fibrous structure is molded against the imprinting fabric prior to completion of drying by application of fluid pressure with a vacuum device such as a suction box, or with a blow-through dryer. Fluid pressure may be applied to induce impression of densified zones during initial dewatering, in a separate, subsequent process stage, or a combination thereof.

Typically, it is this drying/imprinting fabric which induces the structure to have differential density, although other methods of patterned densifying are possible and included within the scope of the invention. Differential density structures may comprise a field of low density with discrete high density areas distributed within the field. They may alternately or further comprise a field of high density with discrete low density areas distributed within that field. It is also possible for a differential density pattern to be strictly composed of discrete elements or regions , i.e. elements or regions which are not continuous. Continuous elements or regions are defined as those which extend to terminate at all edges of the periphery of the repeating unit (or useable unit in the event that the pattern does not repeat within such useable unit).

Most commonly, differential density structures comprise two distinct densities; however, three or more densities are possible and included within the scope of this invention. For purposes of this invention, a region is referred to as a “low density region” if it possesses a density less than the mean density of the entire structure. Likewise, a region is referred to as a “high density region” if it possesses a density greater than the mean density of the entire structure.

The differential density structure of the present invention possesses a “structural aspect ratio”. Physically, this structural aspect ratio relates to the average directionality of the shapes of the discrete areas within the overall field. Note that each discrete area possesses an aspect ratio. The overall structure has an aspect ratio which is the weighted average of each of the individual discrete area aspect ratios. The weighting is done by multiplying the aspect ratio of each discrete region by its respective area, summing all of the products and dividing that sum by the total area of discrete regions. The algorithm for determining structural aspect ratio essentially consists of repeating this process, trying every direction 180° around the structure, until the direction is found which calculates to the highest aspect ratio; this is referred to as the structural aspect ratio and the direction to which it corresponds is referred to as the structural aspect ratio direction.

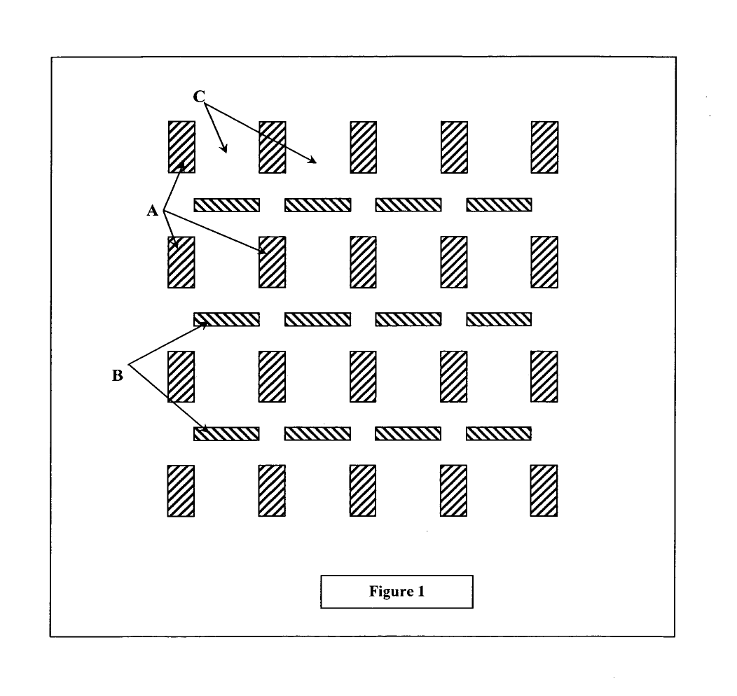

The Figures provide an illustration for a relatively simple pattern comprised of discrete low density areas (shaded), dispersed within a high density (unshaded) field. In FIG. 1, it is illustrated that there are two low density shape types “A” and “B”, dispersed within a continuous, high density field “C”.

The first step in calculating structural aspect ratio is selection of a repeating pattern. In the case of FIG. 1, the repeat unit is fairly simple and requires only two adjacent regions of type “A” and the associated region of type “B” in order to define a group of regions which, when replicated, repeat the entire patterned densified structure. Much more complex repeat patterns are possible, indeed it is envisioned that the repeating field may be infinite (i.e. non-repeating) or at least so large that it does not repeat within a useable unit of product. For those cases, the repeat area is selected to be the useable unit itself.

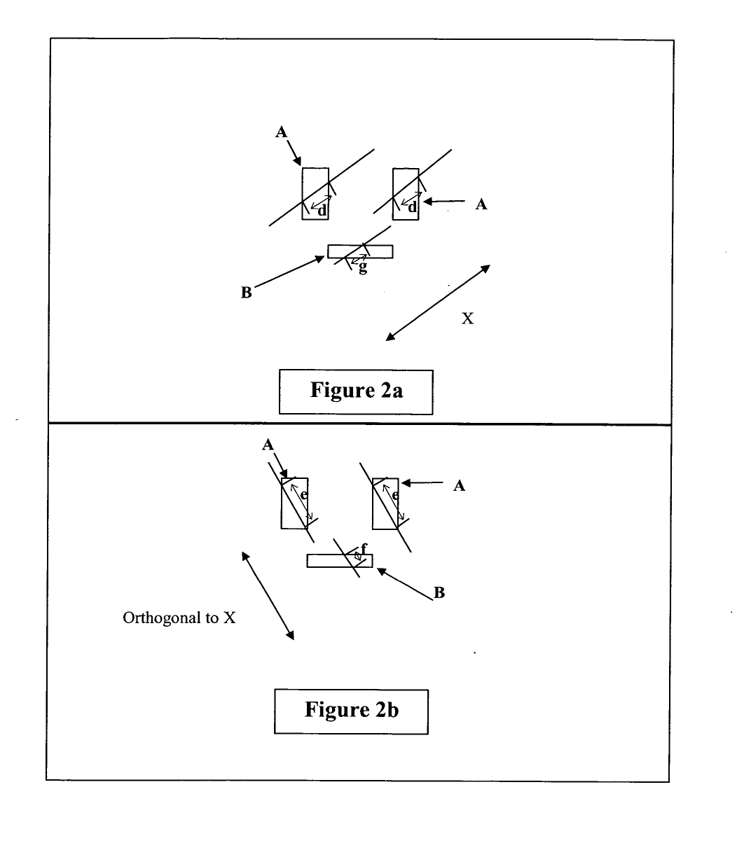

FIGS. 2a and 2b concentrates on the repeating group of region and illustrates how to calculate the aspect ratio in a certain direction, “X”. Referring to FIG. 2a., the discrete areas “A” possess a length “d” in direction “X”. Note, the selection of which of infinite possible parallel lines to draw across region “A” to determine “d” involves selecting any of such parallel lines which maximizes “d”. Likewise, lines in direction “X” define a length “g” across regions of type “B”. FIG. 2b illustrates the widths of regions “A” and “B” determined by envisioning parallel lines orthogonal to “X” selected, likewise, to maximize “e” and “f”, the respective widths across regions of types “A” and “B”, respectively.

The aspect ratio in direction “X” of regions of type “A” is thus determined by the ratio of d/e, while the aspect ratio of regions of type “B” are similarly determined by the ratio of g/f.

The aspect ratio in direction “X” is determined by weighted average combining, thus:

$$Aspect Ratio in Direction “ X ” = \frac{\begin{matrix}( Area of “ A ” * d / e ) + \\ ( Area of “ A ” * d / e ) + ( Area of “ B ” * g / f )\end{matrix}}{Area of “ A ” + Area of “ A ” + Area of “ B ”}$$

wherein * represents a multiplication sign.

Finally, the structural aspect ratio is determined by repeating this calculation for each “X”, trying every direction 180° around the structure, until a maximum is found. This maximum is the structural aspect ratio and its direction is the structural aspect ratio direction. It is recognized that certain structures will not possess a unique maximum when all possible X's are trialed. In this case, the direction most closely representing the machine direction is to be selected.

The foregoing methodology to calculate aspect ratio can best be determined by using the patterned imprinting fabric or the like which is used to impart the structural features to the product. Of course, the structure itself can be imaged to allow the calculation. When the structure itself is to be used, it is critical to remove the artifact of any dry end crepe or the like by examining the structure only after it has been extended to peak load stretch using the tensile test methodology described in the foregoing in a fashion modified to stop the elongation while testing at peak load to prevent destroying the specimen. This pre-stressing should be conducted in the machine direction, or, if the machine direction is unknown, in the direction displaying the maximum stretch.

The fibrous structure of the present invention may comprise a fibrous furnish comprising a short fiber furnish comprising a short fiber having an average fiber length, L, of less than about 1.5 mm and/or from about 0.2 mm to about 1.5 mm and/or from about 0.4 mm to about 1.2 mm.

The short fibers having an average fiber length, L, of less than about 1.5 mm may be present in the fibrous structure at a level of at least 10% by weight of the total fibers, and/or at a level of at least 20% up to 100% by weight of the total fibers of the fibrous structure.

Overall, the average fiber length, L, taking all of the furnish into account, is less than about 2.0 mm, preferably less than about 1.8 mm, and most preferably less than about 1.6 mm.

If the fibrous structure of the present invention is layered, then each layer may comprise different fiber types (long, short, hardwood, softwood, curled/kinked, linear). Layered fibrous structures are well known in the art as exemplified in U.S. Pat. Nos. 3,994,771, 4,300,981 and 4,166,001 and European Patent Publication No. 613 979 A1. Fibers typically being relatively long softwood and relatively short hardwood fibers are used in multi-layered fibrous structure papermaking processes. Multi-layered fibrous structures suitable for the present invention may comprise at least two superposed layers, an inner layer and at least one outer layer contiguous with the inner layer. Preferably, the multi-layered fibrous structures comprise three superposed layers, an inner or center layer, and two outer layers, with the inner layer located between the two outer layers. The two outer layers preferably comprise a primary filamentary constituent of about 60% or more by weight of relatively short papermaking fibers having an average fiber length, L, of less than about 1.5 mm. These short papermaking fibers are typically hardwood fibers, preferably hardwood Kraft fibers, and most preferably derived from eucalyptus. The inner layer preferably comprises a primary filamentary constituent of about 60% or more by weight of relatively long papermaking fibers having an average fiber length, L, of greater than or equal to about 1.5 mm. These long papermaking fibers are typically softwood fibers, preferably, northern softwood Kraft fibers.

In one embodiment, a fibrous structure, preferably a differential density fibrous structure, comprises two or more layers of fibers, wherein at least one of the two or more layers has an average fiber length, L, of greater than or equal to 1.5 mm and at least one of the other layers has an average fiber length, L, of less than 1.5 mm.

In another embodiment, a fibrous structure, preferably a differential density fibrous structure, comprises two or more layers of fibers, wherein at least one of the two or more layers has an average fiber length, L, of greater than or equal to 1.5 mm and is positioned between two layers having an average fiber length, L, of less than 1.5 mm.

The fibrous structure may be foreshortened, such as via creping and/or microcontraction and/or rush transferring, or non-forshortened, such as not creping; creped from a cylindrical dryer with a creping doctor blade, removed from a cylindrical dryer without the use of a creping doctor blade, or made without a cylindrical dryer.

The fibrous structure of the present invention may comprise any suitable ingredients known in the art. Nonlimiting examples of suitable ingredients that may be included in the fibrous structures include permanent and/or temporary wet strength resins, dry strength resins, softening agents, wetting agents, lint resisting agents, absorbency-enhancing agents, immobilizing agents, especially in combination with emollient lotion compositions, antiviral agents including organic acids, antibacterial agents, polyol polyesters, antimigration agents, polyhydroxy plasticizers, opacifying agents and mixtures thereof. Such ingredients, when present in the fibrous structure of the present invention, may be present at any level based on the dry weight of the fibrous structure. Typically, such ingredients, when present, may be present at a level of from about 0.001 to about 50% and/or from about 0.001 to about 20% and/or from about 0.01 to about 5% and/or from about 0.03 to about 3% and/or from about 0.1 to about 1.0% by weight, on a dry fibrous structure basis.

In one embodiment, fibrous structures of the present invention comprise temporary wet strength agents and/or softening agents.

Further, such ingredients, when present in the fibrous structure, may be added to the wet end (in the furnish or to a fibrous structure having a solids content of less than about 50% directly or indirectly) or the dry end (to a fibrous structure having a solids content of greater than about 50% directly or indirectly) of the fibrous structure papermaking process.

Further yet, the fibrous structures of the present invention may comprise an undulatory surface.

Embodiments of the present invention include those in which the fibrous structure may have a structural aspect ratio greater than about 1.5 and/or greater than about 2 and/or greater than about 4 while having a modulus to tensile strength ratio less than about 15 and/or less than about 10 and/or less than about 7, wherein the modulus to tensile strength ratios are determined in the direction orthogonal to the structural aspect ratio direction. Any combination of structural aspect ratios and/or modulus to tensile strength ratios may be present in the fibrous structures according to the present invention.

Even further embodiments of the present invention include those in which the fibrous structure has an average fiber length, L, of less than about 2 mm and/or less than about 1.8 mm and/or less than about 1.6 mm whilst having a maximum stretch less than about 15% and/or less than about 12.5% and/or less than about 10%; and a modulus to tensile strength ratio less than about 15 and/or less than about 10 and/or less than about 7; wherein the modulus to tensile strength ratios are determined in the direction of maximum stretch. Any combination of average fiber lengths and/or modulus to tensile strength ratios and/or maximum stretch may be present in the fibrous structures according to the present invention.

### EXAMPLES

Nonlimiting examples of fibrous structures are provided below.

### Example 1

The following Example illustrates preparation of a fibrous structure according to the prior art. A pilot-scale Fourdrinier papermaking machine is used for the production of the fibrous structure.

An aqueous slurry of NSK of about 3% consistency is made up using a conventional repulper and is passed through a stock pipe toward the headbox of the Fourdrinier.

In order to impart temporary wet strength to the finished product, a 1% dispersion of Parez 750® is prepared and is added to the NSK stock pipe at a rate sufficient to deliver 0.3% Parez 750® based on the dry weight of the NSK fibers. The absorption of the temporary wet strength resin is enhanced by passing the treated slurry through an in-line mixer.

An aqueous slurry of eucalyptus fibers of about 3% by weight is made up using a conventional repulper.

The NSK fibers are diluted with white water at the inlet of a fan pump to a consistency of about 0.15% based on the total weight of the NSK fiber slurry. The eucalyptus fibers, likewise, are diluted with white water at the inlet of a fan pump to a consistency of about 0.15% based on the total weight of the eucalyptus fiber slurry. The eucalyptus slurry and the NSK slurry are both directed to a layered headbox capable of maintaining the slurries as separate streams until they are deposited onto a forming fabric on the Fourdrinier.

The paper machine has a layered headbox having a top chamber, a center chamber, and a bottom chamber. The eucalyptus fiber slurry is pumped through the top and bottom headbox chambers and, simultaneously, the NSK fiber slurry is pumped through the center headbox chamber and delivered in superposed relation onto the Fourdrinier wire to form thereon a three-layer embryonic web, of which about 70% is made up of the eucalyptus fibers and 30% is made up of the NSK fibers. This combination results in an average fiber length, L, of about 1.6 mm. Dewatering occurs through the Fourdrinier wire and is assisted by a deflector and vacuum boxes. The Fourdrinier wire is of a 5-shed, satin weave configuration having 87 machine-direction and 76 cross-machine-direction monofilaments per inch, respectively. The speed of the Fourdrinier wire is about 650 fpm (feet per minute) (about 198 meters per minute).

The embryonic wet web is transferred from the Fourdrinier wire, at a fiber consistency of about 15% at the point of transfer, to a patterned drying fabric. The speed of the patterned drying fabric is the same as the speed of the Fourdrinier wire. The drying fabric is designed to yield a pattern densified tissue with discontinuous low-density deflected areas arranged within a continuous network of high density (knuckle) areas. This drying fabric is formed by casting an impervious resin surface onto a fiber mesh supporting fabric. The supporting fabric is a 45×52 filament, dual layer mesh. The thickness of the resin cast is about 15 mil above the supporting fabric. The resin cast is deposited in form described as “the web making belt” in copending U.S. application Ser. No. 10/288,036. The structural aspect ratio of this pattern is 1.09. The knuckle area is about 40%.

Further de-watering is accomplished by vacuum assisted drainage until the web has a fiber consistency of about 30%.

While remaining in contact with the patterned drying fabric, the web is pre-dried by air blow-through pre-dryers to a fiber consistency of about 65% by weight.

The semi-dry web is then transferred to the Yankee dryer and adhered to the surface of the Yankee dryer with a sprayed creping adhesive. The creping adhesive is an aqueous solution with the actives in solution consisting of about 50% polyvinyl alcohol, about 35% CREPETROL A3025, and about 15% CREPETROL R6390. CREPETROL A3025 and CREPETROL R6390 are commercially available from Hercules Incorporated of Wilmington, Del. The creping adhesive is delivered to the Yankee surface at a rate of about 0.15% adhesive solids based on the dry weight of the web. The fiber consistency is increased to about 96% before the web is dry creped from the Yankee with a doctor blade.

The doctor blade has a bevel angle of about 25 degrees and is positioned with respect to the Yankee dryer to provide an impact angle of about 81 degrees. The Yankee dryer is operated at a temperature of about 350° F. (177° C.) and a speed of about 650 fpm. The fibrous structure is wound in a roll using a surface driven reel drum having a surface speed of about 533 feet per minute.

The fibrous structure is subsequently converted into a single-ply sanitary tissue product having a basis weight of about 34 g/m2. The maximum stretch the fibrous structure is measured to be about 28%, the MSD M is about 283 g/cm, and the MSD T is about 95 g/cm. Consequently, the (MSD M/MSD T) is about 3.0

### Example 2

The following Example illustrates preparation of fibrous structure according to one aspect of the present invention.

The same preparation as Example 1 is used for the preparation of Example 2 except for the following:
While remaining in contact with the patterned drying fabric, the web is pre-dried by air blow-through pre-dryers to a fiber consistency of about 65% by weight.

The semi-dry web is then transferred to the Yankee dryer and adhered to the surface of the Yankee dryer with a sprayed creping adhesive. The creping adhesive is an aqueous solution with the actives in solution consisting of about 40% polyvinyl alcohol, about 40% CREPETROL A3025, and about 20% CREPETROL R6390. CREPETROL A3025 and CREPETROL R6390 are commercially available from Hercules Incorporated of Wilmington, Del. The creping adhesive is delivered to the Yankee surface at a rate of about 0.10% adhesive solids based on the dry weight of the web. The fiber consistency is increased to about 96% before the web is dry creped from the Yankee with a doctor blade.

The doctor blade has a bevel angle of about 25 degrees and is positioned with respect to the Yankee dryer to provide an impact angle of about 81 degrees. The Yankee dryer is operated at a temperature of about 350° F. (177° C.) and a speed of about 650 fpm. The fibrous structure is wound in a roll using a surface driven reel drum having a surface speed of about 630 fpm.

The fibrous structure is subsequently converted into a single-ply sanitary tissue product having a basis weight of about 34 g/m². The maximum stretch of the fibrous structure is measured to be about 13%, the MSD M is about 1134 g/cm, and the MSD T is about 178 g/cm. Consequently, the (MSD M/MSD T) is about 6.4

### Example 3

The following Example illustrates preparation of fibrous structure according to an alternate embodiment of the present invention.

The same preparation as Example 1 is used for the preparation of Example 3 except for the following:
The speed of the Fourdrinier wire is about 813 fpm (feet per minute) (about 248 meters per minute).
The embryonic wet web is transferred from the Fourdrinier wire, at a fiber consistency of about 15% at the point of transfer, to a patterned drying fabric. The speed of the patterned drying fabric is about 650 fpm, i.e. about 20% less than the speed of the Fourdinier wire. The drying fabric is designed to yield a pattern densified tissue with low-density deflected areas alternately arranged with high density (knuckle) areas. This drying fabric is formed by casting an impervious resin surface onto a fiber mesh supporting fabric. The supporting fabric is a 45×52 filament, dual layer mesh. The thickness of the resin cast is about 15 mil above the supporting fabric. The pattern of the cast resin has knuckle lines oriented in the MD. The MD knuckle lines are 0.5 mm wide and repeat every 3 mm. The knuckle area is about 17%.

Further de-watering is accomplished by vacuum assisted drainage until the web has a fiber consistency of about 30%.

While remaining in contact with the patterned forming fabric, the web is pre-dried by air blow-through pre-dryers to a fiber consistency of about 65% by weight.

The semi-dry web is then transferred to the Yankee dryer and adhered to the surface of the Yankee dryer with a sprayed creping adhesive. The creping adhesive is an aqueous solution with the actives in solution consisting of about 40% polyvinyl alcohol, about 40% CREPETROL A3025, and about 20% CREPETROL R6390. CREPETROL A3025 and CREPETROL R6390 are commercially available from Hercules Incorporated of Wilmington, Del. The creping adhesive is delivered to the Yankee surface at a rate of about 0.10% adhesive solids based on the dry weight of the web. The fiber consistency is increased to about 96% before the web is dry creped from the Yankee with a doctor blade.

The doctor blade has a bevel angle of about 25 degrees and is positioned with respect to the Yankee dryer to provide an impact angle of about 81 degrees. The Yankee dryer is operated at a temperature of about 350° F. (177° C.) and a speed of about 650 fpm. The fibrous structure is wound in a roll using a surface driven reel drum having a surface speed of about 630 fpm.

The knuckle and pillow regions terminate only at two edges of the useable unit; therefore the regions are both designated as discrete and therefore both the low and high density regions are used in calculating the structural aspect ratio. Useable unit dimensions of the finished product are 102 mm long by 114 mm wide. The structural aspect ratio is calculated to be 68.

The fibrous structure is subsequently converted into a single-ply toilet tissue having a basis weight of about 34 g/m². The ARD₉₀M is determined to be about 507 g/cm and the ARD₉₀T to be about 64 g/cm. Consequently, ARD₉₀M/ARD₉₀T is about 7.9

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A differential density fibrous structure comprising a structural aspect ratio of greater than 1.5 wherein the fibrous structure exhibits a modulus to tensile strength ratio as defined below:
$$\frac{{ARD}_{90} M}{{ARD}_{90} T} < 15$$
wherein ARD₉₀M is the modulus measured perpendicular to the direction the structural aspect ratio is measured; and ARD₉₀ T is the tensile strength measured perpendicular to the direction the structural aspect ratio is measured.

2. The differential density fibrous structure according to claim 1 wherein the modulus to tensile strength ratio is less than about 10.

3. The differential density fibrous structure according to claim 1 wherein the modulus to tensile strength ratio is less than about 7.

4. The differential density fibrous structure according to claim 1 wherein the structural aspect ratio is greater than about 2.

5. The differential density fibrous structure according to claim 1 wherein the structural aspect ratio is greater than about 4.

6. The differential density fibrous structure according to claim 1 wherein the modulus to tensile strength ratio is less than about 10 and the structural aspect ratio is greater than about 2.

7. The differential density fibrous structure according to claim 1 wherein the modulus to tensile strength ratio is less than about 10 and the structural aspect ratio is greater than about 4.

8. The differential density fibrous structure according to claim 1 wherein the modulus to tensile strength ratio is less than about 7 and the structural aspect ratio is greater than about 2.

9. The differential density fibrous structure according to claim 1 wherein the modulus to tensile strength ratio is less than about 7 and the structural aspect ratio is greater than about 4.

10. The differential density fibrous structure according to claim 1 wherein the differential density fibrous structure further comprises an ingredient selected from the group consisting of temporary wet strength resins, softening agents and mixtures thereof.

11. The differential density fibrous structure according to claim 1 wherein the differential density fibrous structure comprises an undulatory surface.

12. The differential density fibrous structure according to claim 1 wherein the differential density fibrous structure comprises two or more layers of fibers.

13. The differential density fibrous structure according to claim 12 wherein at least one of the two or more layers has an average fiber length, L, of greater than or equal to 1.5 mm and at least one of the other layers has an average fiber length, L, of less than 1.5 mm.

14. The differential density fibrous structure according to claim 13 wherein the at least one of the two or more layers having an average fiber length, L, of greater than or equal to 1.5 mm is positioned between two layers having an average fiber length, L, of less than 1.5 mm.

15. A single- or multi-ply sanitary tissue product comprising a differential density fibrous structure according to claim 1.

16. A differential density fibrous structure having an average fiber length, L, of less than 2 mm, the fibrous structure comprising a maximum stretch of less than about 15% wherein the differential density fibrous structure exhibits a modulus to tensile strength ratio as defined below:

| | |
|---|---|
| MSD M | <15 |
| MSD T | |

wherein MSD M is the modulus measured in the direction of the maximum stretch; and MSD T is the tensile strength measured in the direction of the maximum stretch.

17. The differential density fibrous structure according to claim 16 wherein the modulus to tensile strength ratio is less than about 10.

18. The differential density fibrous structure according to claim 16 wherein the modulus to tensile strength ratio is less than about 7.

19. The differential density fibrous structure according to claim 16 wherein the maximum stretch is less than about 12.5%.

20. The differential density fibrous structure according to claim 16 wherein the maximum stretch is less than about 10%.

21. The differential density fibrous structure according to claim 16 wherein the modulus to tensile strength ratio is less than about 10 and the maximum stretch is less than about 12.5%.

22. The differential density fibrous structure according to claim 16 wherein the modulus to tensile strength ratio is less than about 10 and the maximum stretch is less than about 10%.

23. The differential density fibrous structure according to claim 16 wherein the modulus to tensile strength ratio is less than about 7 and the maximum stretch is less than about 12.5%.

24. The differential density fibrous structure according to claim 16 wherein the modulus to tensile strength ratio is less than about 7 and the maximum stretch is less than about 10%.

25. The differential density fibrous structure according to claim 16 wherein the differential density fibrous structure further comprises an ingredient selected from the group consisting of temporary wet strength resins, softening agents and mixtures thereof.

26. The differential density fibrous structure according to claim 16 wherein the differential density fibrous structure comprises an undulatory surface.

27. The differential density fibrous structure according to claim 16 wherein the differential density fibrous structure comprises two or more layers of fibers.

28. The differential density fibrous structure according to claim 27 wherein at least one of the two or more layers has an average fiber length, L, of greater than or equal to 1.5 mm and at least one of the other layers has an average fiber length, L, of less than 1.5 mm.

29. The differential density fibrous structure according to claim 28 wherein the at least one of the two or more layers having an average fiber length, L, of greater than or equal to 1.5 mm is positioned between two layers having an average fiber length, L, of less than 1.5 mm.

30. The differential density fibrous structure according to claim 16 wherein the average fiber length, L, is less than about 1.8 mm.

31. A single- or multi-ply sanitary tissue product comprising a differential density fibrous structure according to claim 16.
